(19) United States
(12) Patent Application Publication
(10) Pub. No.: US 2025/0244447 A1
(43) Pub. Date: Jul. 31, 2025

(54) SIGNAL PROCESSING METHOD, DEVICE, AND STORAGE MEDIUM

(71) Applicant: SUZHOU SUSHI TESTING GROUP CO., LTD., Suzhou, Jiangsu (CN)

(72) Inventors: Jiuzhao SHENG, Suzhou (CN); Qionghua ZHONG, Suzhou (CN)

(73) Assignee: SUZHOU SUSHI TESTING GROUP CO., LTD., Suzhou, Jiangsu (CN)

(21) Appl. No.: 18/703,441

(22) PCT Filed: Nov. 25, 2021
(86) PCT No.: PCT/CN2021/133213

§ 371 Date: Apr. 22, 2024

(30) Foreign Application Priority Data
Nov. 12, 2021 (CN) 202111341205.2

(51) Int. Cl. G01S 7/41; G01S 7/02

(52) U.S. Cl. CPC G01S 7/411; G01S 7/023

(57) ABSTRACT

The present application discloses a signal processing method, device, and storage medium. The signal processing method comprises: acquiring a scanned target collection and multiple initial targets, and dividing them into multiple clusters; performing signal-to-noise ratio statistical analysis and false target statistical analysis on each first cluster among the multiple clusters, thereby removing initial targets with non-compliant signal-to-noise ratio and false targets. The signal processing method is capable of identifying and eliminating initial targets with non-compliant signal-to-noise ratio and false targets.

### CROSS-REFERENCE TO RELATED APPLICATIONS

This application is the National Phase of PCT International Application No. PCT/CN2021/133213, filed on Nov. 25, 2021, which claims priority under 35 U.S.C. 119(a) to Patent Application No. 202111341205.2, filed in China on Nov. 12, 2021, entitled “Signal Processing Method, Device, Storage Medium, and Electronic Terminal”, all of which are hereby expressly incorporated by reference into the present application.

### TECHNICAL FIELD

The present application relates to the field of radar technology, and more particularly to a signal processing method, device, and storage medium.

### BACKGROUND

Radar is an electronic device that detects initial targets using electromagnetic waves by emitting electromagnetic waves to illuminate initial targets and receiving echoes, thereby obtaining information such as distances, speeds, and azimuths of the initial targets from an electromagnetic wave emission point.

In modem radar countermeasure systems, interference can be categorized into active interference and passive interference based on the source of interference energy. It is understandable that when a radar is interfered with, initial targets identified by the radar include both real initial targets and false initial targets.

Therefore, when a radar is interfered with, identifying real initial targets and false initial targets becomes an urgent problem to be solved.

### SUMMARY

In view of background technologies, main objectives of the present application are to provide a signal processing method, device, storage medium, and electronic terminal.

To achieve one of the above objectives, a technical solution of the present application is implemented as follows: A signal processing method for radar systems, comprising following steps:
acquiring a scanned target collection, which includes Num1 initial targets and corresponding Num1 attribute values, controlling a radar system to perform a scanning operation, and obtaining Num2 initial targets and corresponding Num2 attribute values based on a radar echo signal, where the attribute values include at least: an azimuth AZ of the initial target, appearance time of the initial target, amplitude of the radar echo signal, and signal-to-noise ratio S_N of the radar echo signal, with Num1 and Num2 being natural numbers;
copying the Num1 initial targets into corresponding Num1 targets to be processed, and copying the Num2 initial targets into corresponding Num2 targets to be processed; dividing Num1+Num2 targets to be processed into multiple clusters based on a clustering algorithm and azimuths AZ of the Num1+Num2 targets to be processed;
performing a processing as follows on each second cluster among the multiple clusters: deleting a second cluster if signal-to-noise ratio S_N of targets to be processed in the second cluster does not meet a preset condition;
performing a first processing on each first cluster among the multiple clusters: counting M targets to be processed in the first cluster, where an absolute value of difference between an appearance time of the M targets to be processed and a current time is less than a first preset time threshold ΔTime1; dividing the M targets to be processed into N clusters when M is greater than a first preset quantity threshold, where in each cluster among the N clusters, an absolute value of difference in amplitude between any two targets to be processed is less than a preset amplitude threshold; deleting a cluster when a number of targets to be processed contained in the cluster is greater than a second preset quantity threshold, for any cluster; performing a second processing on each remaining cluster: determining a first target to be processed is same as a second target to be processed when an absolute value of difference in azimuth AZ between the first target to be processed and the second target to be processed is less than an azimuth difference threshold ΔAZ;
and determining a first target to be processed is a new target when an absolute value of difference in azimuth AZ between the first target to be processed and any initial target among the Num1 initial targets is greater than or equal to an azimuth difference threshold ΔAZ; where the first target to be processed is any target to be processed in the cluster, the second target to be processed is any initial target among the Num1 initial targets, M and N are natural numbers, N≤M; performing a next second processing when there are still clusters that have not undergone the second processing; and performing a next first processing when there are still first clusters that have not undergone the first processing.

In an embodiment of the present application, the “dividing Num1+Num2 targets to be processed into multiple clusters based on a clustering algorithm and azimuths AZ of the Num1+Num2 targets to be processed” specifically comprises: processing the Num1+Num2 targets to be processed as follows until all the Num1+Num2 targets to be processed have been processed; and the processing on the Num1+Num2 targets to be processed specifically comprises: selecting an unprocessed third target to be processed from the Num1+Num2 targets to be processed, creating a cluster that only comprises the third target to be processed, marking the third target to be processed as processed, and determining each fourth target to be processed among the Num1+Num2 targets to be processed as follows: adding the fourth target to be processed to the cluster, and marking the fourth target to be processed as processed when a fourth initial target is unprocessed, and an absolute value of difference in azimuth AZ between the third target to be processed and an average azimuth of all targets to be processed in the cluster is less than the azimuth difference threshold ΔAZ.

In an embodiment of the present application, the “deleting a second cluster if signal-to-noise ratio S_N of targets to be processed in the second cluster does not meet a preset condition” specifically comprises: obtaining a number Counter1 of fifth targets to be processed in the second cluster and a number Counter2 of sixth targets to be processed in the second cluster, where an absolute value of difference between an appearance time of the fifth target to be processed and a current time is less than or equal to a first preset time threshold ΔTime1, and an absolute value of difference between a signal-to-noise ratio S_N of the sixth target to be processed and a preset signal-to-noise ratio value is less than or equal to a preset signal-to-noise ratio threshold ΔS_N; deleting the second cluster if Counter2/Counter1 is greater than a preset percentage value.

In an embodiment of the present application, a preset percentage value is 0.9.

In an embodiment of the present application, the “deleting a second cluster if signal-to-noise ratio S_N of targets to be processed in the second cluster does not meet a preset condition” specifically comprises: deleting the second cluster and adjusting a rotational speed of the radar system and a transmission frequency of the radar system if the signal-to-noise ratio S_N of the targets to be processed in the second cluster does not meet the preset condition.

In an embodiment of the present application, the “determining a first target to be processed is same as a second target to be processed when an absolute value of difference in azimuth AZ between the first target to be processed and the second target to be processed is less than an azimuth difference threshold ΔAZ” specifically comprises: determining a first target to be processed is same as a second target to be processed and updating attribute values of a seventh target to be processed in the scanned target collection with attribute values of the first target to be processed when the absolute value of the difference in azimuth AZ between the first target to be processed and the second target to be processed is less than the azimuth difference threshold ΔAZ, where content of the second target to be processed is the same as content of the seventh target to be processed;
the “determining a first target to be processed is a new target when an absolute value of difference in azimuth AZ between the first target to be processed and any initial target among the Num1 initial targets is greater than or equal to an azimuth difference threshold ΔAZ” specifically comprises: determining a first target to be processed is a new target and adding the first target to be processed to the scanned target collection when the absolute value of the difference in azimuth AZ between the first target to be processed and any initial target among the Num1 initial targets is greater than or equal to the azimuth difference threshold ΔAZ.

In an embodiment of the present application, the signal processing method further comprises following steps: performing a processing as follows on each initial target in the scanned target collection: removing an initial target from the scanned target collection when an absolute value of difference between a most recent appearance time of the initial target and a current time is less than a second preset time threshold ΔTime2.

The present application provides a signal processing device for radar systems in an embodiment, comprising following modules:
a data acquisition module, configured to acquire a scanned target collection, which includes Num1 initial targets and corresponding Num1 attribute values, control a radar system to perform a scanning operation, and obtain Num2 initial targets and corresponding Num2 attribute values based on a radar echo signal, where the attribute values include at least: an azimuth AZ of the initial target, appearance time of the initial target, amplitude of the radar echo signal, and signal-to-noise ratio S_N of the radar echo signal, with Num1 and Num2 being natural numbers;
a clustering module, configured to copy the Num1 initial targets into corresponding Num1 targets to be processed, and copy the Num2 initial targets into corresponding Num2 targets to be processed; and configured to divide Num1+Num2 targets to be processed into multiple clusters based on a clustering algorithm and azimuths AZ of the Num1+Num2 targets to be processed;
a noise processing module, configured to perform a processing as follows on each second cluster among the multiple clusters: deleting a second cluster if signal-to-noise ratio S_N of targets to be processed in the second cluster does not meet a preset condition; and
a processing module, configured to perform a first processing on each first cluster among the multiple clusters: counting M targets to be processed in the first cluster, where an absolute value of difference between an appearance time of the M targets to be processed and a current time is less than a first preset time threshold ΔTime1; configured to divide the M targets to be processed into N clusters when M is greater than a first preset quantity threshold, where in each cluster among the N clusters, an absolute value of difference in amplitude between any two targets to be processed is less than a preset amplitude threshold; configured to delete a cluster when a number of targets to be processed contained in the cluster is greater than a second preset quantity threshold, for any cluster; configured to perform a second processing on each remaining cluster: determining a first target to be processed is same as a second target to be processed when an absolute value of difference in azimuth AZ between the first target to be processed and the second target to be processed is less than an azimuth difference threshold ΔAZ; and determining a first target to be processed is a new target when an absolute value of difference in azimuth AZ between the first target to be processed and any initial target among the Num1 initial targets is greater than or equal to an azimuth difference threshold ΔAZ; where the first target to be processed is any target to be processed in the cluster, the second target to be processed is any initial target among the Num1 initial targets, M and N are natural numbers, N≤M; configured to perform a next second processing when there are still clusters that have not undergone the second processing; and configured to perform a next first processing when there are still first clusters that have not undergone the first processing.

The present application provides a storage medium stored program instructions in an embodiment, characterized in that, when the program instructions are executed, a signal processing method mentioned above is implemented.

The present application provides an electronic terminal in an embodiment, comprising a processor and a memory, with the memory storing program instructions, characterized in that, the processor runs the program instructions to implement a signal processing method mentioned above.

A signal processing method, device, storage medium, and electronic terminal provided in embodiments of the present application have following advantages: The present application discloses a signal processing method, device, storage medium, and electronic terminal in embodiments, with the signal processing method comprising: acquiring a scanned target collection and multiple initial targets, and dividing them into multiple clusters; performing signal-to-noise ratio (SNR) statistical analysis and false target statistical analysis on each first cluster among the multiple clusters, thereby removing initial targets with non-compliant signal-to-noise ratio and false targets. The signal processing method is capable of identifying and eliminating initial targets with non-compliant signal-to-noise ratio and false targets.

### BRIEF DESCRIPTION OF THE DRAWINGS

FIG. 1 shows a structural diagram of a radar provided in an embodiment of the present application;

FIG. 2 shows a structural diagram of a signal processing method provided in an embodiment of the present application;

FIGS. 3, 4, and 5 show schematic diagrams of a signal processing method in embodiments of the present application.

### DETAILED DESCRIPTION

Detailed description of embodiments of the present application is provided below, in conjunction with accompanying drawings. It should be noted that these embodiments do not limit the present application. Structural, methodological, or functional modifications made by those of ordinary skill in art based on these embodiments fall within the scope of protection of the present application.

The following description and accompanying drawings fully illustrate specific embodiments of the present application, enabling those skilled in the art to implement the specific embodiments. Parts and features of some embodiments of the present application can be included in parts and features of other embodiments or replace parts and features of other embodiments. The scope of the embodiments of the present application includes the entire range of claims and all equivalents available to the claims. In the present application, terms such as “first”, “second”, etc., are used only to distinguish one element from another without requiring or implying any actual relationship or order between the elements. Indeed, a first element could also be referred to as a second element, and vice versa. Moreover, terms such as “comprising”, “including”, or any of their other variants are intended to cover a non-exclusive inclusion, so that a structure, device, or apparatus that includes a list of elements not only includes the list of elements but also includes other elements not expressly listed, or elements inherent to such a structure, device, or apparatus. Without further limitation, an element defined by the statement “comprising a . . . ” does not exclude the presence of additional identical elements in the structure, device, or apparatus that comprises the element. Various embodiments in the present application are described in a progressive manner, with each embodiment focusing on differences from other embodiments, and same parts or similar parts between the various embodiments can refer to each other.

The terms “vertical”, “horizontal”, “top”, “bottom”, “front”, “back”, “left”, “right”, “up”, “down”, “inside”, “outside”, and other directional or positional terms used in the present application are based on directions or positions shown in the drawings. The directional or positional terms are used only for convenience in describing the present application and simplifying description and do not indicate or imply that devices or elements referred to must have a particular orientation, be constructed and operated in a particular orientation, and thus should not be considered as limiting the present application. In the present application, unless otherwise specified and limited, the terms “install”, “connect”, “connection”, and the like should be interpreted broadly, for example, the terms could indicate mechanical connections or electrical connections; the terms could indicate internal communications within two elements; the terms could indicate directly connected, or indicate interconnected through intermediaries. For those of ordinary skill in the art, specific meanings of the above terms in the present application can be understood according to specific situations.

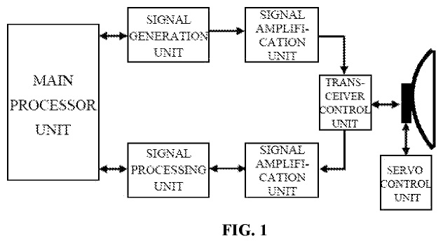

As shown in FIG. 1, a radar system mainly comprises a main processor unit, signal generation unit, signal amplification unit, transceiver control unit, radar antenna, servo control unit, and can further comprise other units. A process of the radar system involves: assuming transmitter power of the radar is Pt and a gain of radar antenna is G, then the power radiated by a radar per unit solid angle is

$$\frac{PtG}{4 π} ;$$

given a target with a reflective area σ and a distance R from a center of the target to a radar antenna, power received by the target (e.g., airplane, etc.) is:

$$\frac{Pt}{4 π} G \frac{σ}{{R}^{2}} ;$$

after the target receiving the power, the power is reflected back into space, and power radiated per unit solid angle is

$$\frac{Pt}{4 π} G \frac{σ}{{R}^{2}} \frac{1}{4 π} ;$$

assuming ‘a beamwidth of the radar antenna is A, the power received by the radar antenna is

$$\frac{Pt}{4 π} G \frac{σ}{{R}^{2}} \frac{A}{4 π} ,$$

where

$$G = \frac{2 π A}{{λ}^{2}} ,$$

where λ is a wavelength of signal transmitted by the radar, then power received by the radar is

$$\frac{{PtG}^{2} {λ}^{2} σ}{{( 4 π )}^{3} {R}^{4}} ;$$

when the power received by the radar is below sensitivity of a radar receiver (which varies with each radar), the radar cannot identify the target; a signal-to-noise ratio of signal received by the radar is

$$\frac{{PtG}^{2} {λ}^{2} σ}{{( 4 π )}^{3} {R}^{4} {L}_{A} {L}_{S} {KT}_{0} BF} ,$$

where L_{A} is a noise amplification factor of the radar receiver, Lₛ is a signal amplification factor of the radar receiver, K is a Boltzmann's constant, T₀ is a room temperature (e.g., T₀ equals to 290K), B is a bandwidth of the radar receiver and F is a noise factor of the radar receiver; and when the signal-to-noise ratio is lower than a minimum signal-to-noise ratio that the radar can receive (which varies with each radar), the radar also cannot identify the target.

Interference to the radar from external sources is mainly of two types: noise and deception. Noise mainly affects a receiver unit of the radar, lowering a signal-to-noise ratio and making it difficult for the radar to identify targets. Deception primarily affects a signal processing unit of radar system by creating false targets, making it challenging for the radar to discern real targets, thus protecting the real targets themselves.

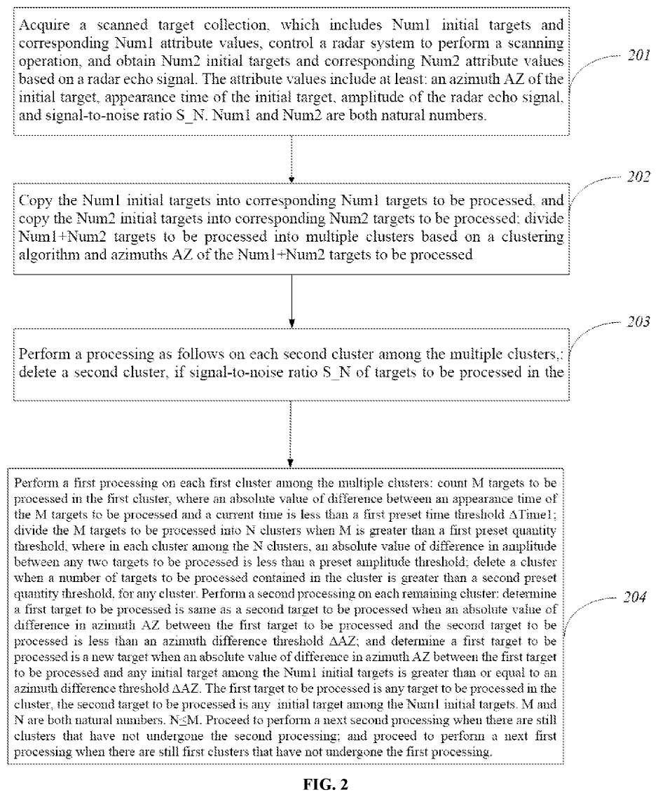

A first embodiment of the present application provides a signal processing method for radar systems, wherein, the radar system can be configured to execute the signal processing method at predetermined intervals, and the signal processing method can be optionally performed by the main processor of the radar system. As shown in FIG. 2, a signal processing method comprises following steps:

step 201: acquire a scanned target collection, which includes Num1 initial targets and corresponding Num1 attribute values, control a radar system to perform a scanning operation, and obtain Num2 initial targets and corresponding Num2 attribute values based on a radar echo signal. The attribute values include at least: an azimuth AZ of the initial target, appearance time of the initial target, amplitude of the radar echo signal, and signal-to-noise ratio (SNR) S_N. Num1 and Num2 are both natural numbers. During the scanning operation, initial target dot information is first obtained based on the radar echo signal, followed by obtaining the initial targets and corresponding attribute values. For each initial target, at least following attribute values are acquired: (1) An azimuth Az of an initial target relative to the radar system during the scanning operation, (2) A current distance between the radar system and an initial target during the scanning operation, (3) An amplitude pa of the radar echo signal from an initial target during the scanning operation, (4) A velocity value of an initial target during the scanning operation, (5) An appearance time appearTime of an initial target. It is understood that a same initial target could be scanned multiple times, thus an array can be used to store the appearTime. The array stores all appearTime of the initial target from its discovery to the current scanning operation, (6) A disappearance time disappearTime of an initial target. Similarly, a same initial target could be scanned multiple times and could disappear multiple times, thus an array can be used to store the disappearTime. The array stores all disappearTime of the initial target from its discovery to the current scanning operation, (7) A signal-to-noise ratio S_N. It is understood that a same initial target could be scanned multiple times, and a signal-to-noise ratio of the radar echo signal of an initial target can be obtained each time the initial target is scanned. Therefore, an array can be used to store the S_N. The array stores all S_N of the initial target from its discovery to the current scanning operation.

In actual programming, a structure can be used to store the attribute value corresponding to the initial target:

Typedef struct StatAnalyzeStru

{
int AZ;
int distance;
int pa;
int velocity;
int appearTimeCnt; // appearTimeCnt is a number of times a same initial

target has been scanned

int appearTime[1024];
int disappearTimeCnt; // disappearTimeCnt is a number of times a same

initial target has disappeared

int disappearTime[1024];
int S_N[1024];
}

After a last execution of the signal processing method, Num1 initial targets were obtained. During the current scanning operation, a total of Num2 initial targets were discovered. Hence, (1) Some of the Num1 initial targets and some of the Num2 initial targets overlap. It is understandable that since the initial target (such as an airplane) are usually moving, the attribute values of a same initial target in a last scanning operation and a current scanning operation are usually not exactly the same (for example, an azimuth AZ, a current distance etc. might differ), and only a very small probability they are exactly the same; (2) Among the Num2 initial targets, some initial targets are new, i.e., not among the Num1 initial targets, and among these new initial targets, some are false initial targets.

Step 202: copy the Num1 initial targets into corresponding Num1 targets to be processed, and copy the Num2 initial targets into corresponding Num2 targets to be processed; divide Num1+Num2 targets to be processed into multiple clusters based on a clustering algorithm and azimuths AZ of the Num1+Num2 targets to be processed. The initial targets and the targets to be processed are in a one-to-one correspondence. Contents of the corresponding initial targets and targets to be processed is consistent, but the content of the initial targets and the content of the targets to be processed are two independent values, meaning modifying the content of the initial targets does not affect the content of the targets to be processed. Similarly, modifying the content of the targets to be processed does not affect the content of the initial targets.

The Num1+Num2 targets to be processed are combined from the aforementioned Num1 targets to be processed and Num2 targets to be processed. The clustering algorithm groups targets to be processed with a similar azimuth AZ into a same cluster. It is understandable that among multiple initial targets with a similar azimuth AZ, some are false initial targets.

Step 203: perform a processing as follows on each second cluster among the multiple clusters: delete a second cluster, if signal-to-noise ratio S_N of targets to be processed in the second cluster does not meet a preset condition. A cluster can be deleted if the signal-to-noise ratio of the cluster does not meet a requirement. The preset condition can be configured as:
determining signal-to-noise ratios S_N of a second cluster do not meet the preset condition if the signal-to-noise ratio S_N of any target to be processed in the second cluster does not meet requirements; or determining signal-to-noise ratios S_N of a second cluster do not meet the preset condition if the signal-to-noise ratios S_N of all targets to be processed in the second cluster do not meet requirements. When the signal-to-noise ratio S_N of the targets to be processed in the second cluster does not meet the preset condition, it can be considered that the signal-to-noise ratio of the radar system has deteriorated, and the collected signal (e.g., the targets to be processed in the second cluster) has a significant error.

Step 204: perform a first processing on each first cluster among the multiple clusters: count M targets to be processed in the first cluster, where an absolute value of difference between an appearance time of the M targets to be processed and a current time is less than a first preset time threshold ΔTime1; divide the M targets to be processed into N clusters when M is greater than a first preset quantity threshold, where in each cluster among the N clusters, an absolute value of difference in amplitude between any two targets to be processed is less than a preset amplitude threshold; delete a cluster when a number of targets to be processed contained in the cluster is greater than a second preset quantity threshold, for any cluster. By counting the number M of targets to be processed in the first cluster, where the absolute value of the difference between the appearance time and the current time is less than the first preset time threshold ΔTime1 (it is understandable that targets in the first cluster meeting this condition are determined to be new targets), it can be understood that when M is greater than the first preset quantity threshold, these new targets in the first cluster could include false targets. Therefore, it is necessary to perform amplitude statistical analysis on the new targets. When the number of targets to be processed in a cluster is greater than the second preset quantity threshold, it can be considered that the targets to be processed in the cluster are temporally, spatially, and amplitude related, originating from a same transmitter, are false targets, and a deletion flag needs to be set.

Meanwhile, perform a second processing on each remaining cluster: determine a first target to be processed is same as a second target to be processed when an absolute value of difference in azimuth AZ between the first target to be processed and the second target to be processed is less than an azimuth difference threshold ΔAZ; and determine a first target to be processed is a new target when an absolute value of difference in azimuth AZ between the first target to be processed and any initial target among the Num1 initial targets is greater than or equal to an azimuth difference threshold ΔAZ. The first target to be processed is any target to be processed in the cluster, the second target to be processed is any initial target among the Num1 initial targets. M and N are both natural numbers. N≤M. Proceed to perform a next second processing when there are still clusters that have not undergone the second processing; and proceed to perform a next first processing when there are still first clusters that have not undergone the first processing. The first preset quantity threshold can be 10, and the second preset quantity threshold can be 10.

Deception (in other words, deception jamming) can be categorized into active interference and passive interference. Active interference involves delaying a radar signal and then relaying the delayed radar signal back to the radar, thus creating numerous false targets, causing the radar to track false targets, and thereby protecting real targets. Additionally, by creating a large number of false targets, ‘a data processing system of the radar (e.g., the radar signal processing unit) can become saturated, eventually ceasing to function properly. Passive interference involves deploying metallic foil strips or flares in front of a target, causing the radar to fail to detect a real target, thereby serving a protective function.

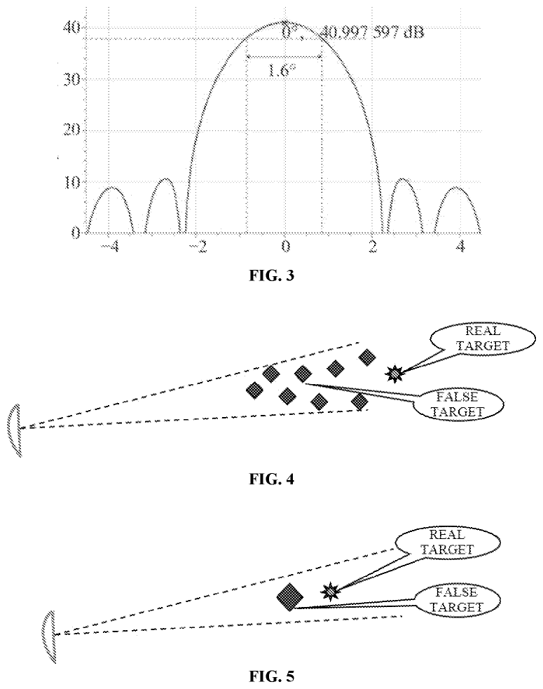

For active interference, ‘an effect model can be analyzed as follows first. FIG. 3 shows a pattern of the radar antenna, where a direction with a strong signal is a main lobe direction, and a direction with a weak signal is a sidelobe direction. Both the main lobe direction and the sidelobe direction receive signals simultaneously. When jamming is implemented, the active interference manifests as capturing many target signals in a certain azimuth domain, as shown in FIG. 4. From a temporal analysis, the active interference appears as emergence of many new targets at a same moment, with new targets and old targets coexisting, and new targets appearing at sensitive times, such as during confrontation exercises, stand-offs, wartime states, etc. From a spatial analysis, the active interference appears as new targets coexisting with old targets within a same azimuth domain. Since false targets are emitted from a same transmitter, their amplitudes are generally same, i.e., amplitude correlated. Based on combat experience, if a large number of targets suddenly appear in the same azimuth and at sensitive times, and they are amplitude correlated, which clearly contradicts the actual situation on the battlefield, it can be determined that the emergence of a large number of new targets is to cover old targets, hence the new targets can be judged as false targets.

For passive interference, jammers deploy metallic foil strips or flares in front of targets, causing the radar to detect only the strips and not the target itself, thereby serving a self-protective function. The interference effect of passive interference is as shown in FIG. 5. From a temporal analysis, the passive interference manifests as new targets appearing and old targets disappearing at a same moment, with the new targets and the old targets having temporal correlation. From a spatial analysis, the passive interference appears as new targets and old targets being in a same azimuth direction, new targets being closer to the radar, and old targets being farther away from the radar. It is understandable that real targets of radar should be continuous both temporally and spatially. Thus, the aforementioned type of temporal alternation of targets and simultaneous appearance of targets is impossible. Moreover, being in the same azimuth direction with one behind the other in distance can illustrate that appearance of new targets is to cover old targets, and thus, new targets could be determined as false targets.

In one embodiment of the present application, the “divide Num1+Num2 targets to be processed into multiple clusters based on a clustering algorithm and azimuths AZ of the Num1+Num2 targets to be processed” specifically comprises:
processing the Num1+Num2 targets to be processed as follows until all the Num1+Num2 targets to be processed have been processed. Before all processing is executed, Num1+Num2 initial targets are defaulted as unprocessed and determined as the Num1+Num2 targets to be processed. After each processing, several initial targets are added to a new cluster, and all initial targets in the new cluster are marked as processed.

The processing on the Num1+Num2 targes to be processed specifically comprises: selecting an unprocessed third target to be processed from the Num1+Num2 targets to be processed, creating a cluster that only comprises the third target to be processed, and marking the third target to be processed as processed, and determining each fourth target to be processed among the Num1+Num2 targets to be processed as follows: adding the fourth target to be processed to the cluster, and marking the fourth target to be processed as processed when a fourth initial target is unprocessed, and an absolute value of difference in azimuth AZ between the third target to be processed and an average azimuth of all targets to be processed in the cluster is less than the azimuth difference threshold ΔAZ.

Each time the processing on the Num1+Num2 targes to be processed is executed, a first initial target not added to any existing cluster is selected from the Num1+Num2 initial targets, and then a new cluster is created (the new cluster only comprises the first initial target). After that, a second initial target not added to any existing cluster or any newly created cluster (i.e., the second initial target is unprocessed) is selected from the Num1+Num2 initial targets, and then an average azimuth m_azAverage of azimuths AZ of all initial targets in the newly created cluster is calculated. If the absolute value of the difference in azimuth AZ between the second initial target and m_azAverage is less than the azimuth difference threshold ΔAZ, it indicates that the second initial target and all initial targets in the cluster are within a same azimuth domain. Subsequently, the second initial target is added to the cluster and is marked as processed. If there are identical initial targets among the Num1 initial targets and the Num2 initial targets, the identical initial targets can also be divided into a same cluster.

It is understood that by iteratively executing the processing on the Num1+Num2 targes to be processed, all initial targets among the Num1+Num2 initial targets can eventually be in a unique cluster. Furthermore, all initial targets within a same unique cluster can have similar azimuth positions.

In actual programming, assume the Num1 initial targets are specifically in a form of StatAnalyzeStruts[1, . . . , Num1], and the Num2 initial targets are specifically in a form of StatAnalyzeStruts[Num1+1, . . . , Num1+Num2]. In StatAnalyzeStruts[Num2], a time of scanning is filled into appearTime[0], and appearTimeCnt is assigned the value of 1.

Subsequently, define an integer array m_arrayCluster[Num1+Num2] and a counter m_iCounter with an initial value of 0, define an analysis flag array m_arraypAnaFlag[Num1+Num2] set entirely to 0, indicating unprocessed, and define an integer variable m_azAverage.

Then, find an index i in the flag array m_arraypAnaFlag that is 0, and fill the index i into m_arrayCluster[miCounter], then increment m_iCounter (i.e., m_iCounter++), set m_azAverage to StatAnalyzeStruts[i].AZ, and set m_arraypAnaFlag[i] to 1.

Then, taking m_azAverage as a reference, find indices j that meet a condition as follows: an absolute value of difference between m_arraypAnaFlag[j].AZ and m_azAverage is less than ΔAZ. If so, fill the index j into m_arrayCluster[m_iCounter], increment m_iCounter (i.e., m_iCounter++), set m_azAverage to (m_azAverage*m_iCounter+m_arraypAnaFlag[j].AZ)/(m_iCounter+1), and set m_arraypAnaFlag[j] to 1.

Repeat the above steps until m_arraypAnaFlag[1, . . . , Num1+Num2] are all set to 1.

In an embodiment of the present application, the “delete a second cluster, if signal-to-noise ratio S_N of targets to be processed in the second cluster does not meet a preset condition” specifically comprises: obtaining a number Counter1 of fifth targets to be processed in the second cluster and a number Counter2 of sixth targets to be processed in the second cluster, where an absolute value of difference between an appearance time of the fifth target to be processed and a current time is less than or equal to a first preset time threshold ΔTime1, and an absolute value of difference between a signal-to-noise ratio S_N of the sixth target to be processed and a preset signal-to-noise ratio value is less than or equal to a preset signal-to-noise ratio threshold ΔS_N; deleting the second cluster if Counter2/Counter1 is greater than a preset percentage value. When Counter2/Counter1 is greater than the preset percentage value, it can be considered that the signal-to-noise ratio of the radar system has deteriorated, and the collected signal (e.g., the targets to be processed in the second cluster) has a significant error.

In one embodiment of the present application, a preset percentage value is 0.9.

In one embodiment of the present application, the “delete a second cluster, if signal-to-noise ratio S_N of targets to be processed in the second cluster does not meet a preset condition” specifically comprises: deleting the second cluster and adjusting a rotational speed of the radar system and a transmission frequency of the radar system if the signal-to-noise ratio S_N of the targets to be processed in the second cluster does not meet the preset condition.

Adjusting the ‘rotational speed of the radar system and the transmission frequency of the radar system specifically comprises: acquiring a value m_rotateVelocity of a current rotational speed period of the radar system and a time m_rotateTime of initiating an adjustment of rotational speed period. If an absolute value of difference between m_rotateTime and current time is less than 3*m_rotateVelocity (i.e., 3 times m_rotateVelocity), it indicates that the speed of the radar system was just adjusted, further observation is needed, no action is taken, and return. If 3*m_rotateVelocity is less than or equal to an absolute value of difference between m_rotateTime and current time, and the absolute value of the difference between m_rotateTime and current time is less than 100*m_rotateVelocity (i.e., 100 times m_rotateVelocity), it indicates that the speed of the radar system has been adjusted, but an effect of the adjustment is not ideal, necessitating a change in the transmission frequency of the radar system to a next frequency point. Otherwise, adjust to a next rotational speed, and return.

The noise interference experienced by the radar system can be categorized into co-frequency noise interference, sweep frequency noise interference, and hop frequency noise interference, where sweep interference and frequency modulation interference are also known as intermittent interference. If the interference persists, the interference can be determined through changing ‘a rotational speed of the radar antenna whether it is a continuous co-frequency interference or an intermittent interference. If the interference is determined as an intermittent interference, when a ‘rotational speed of radar and an interference period in a direction of the rotational speed are co-frequency or harmonic, the interference appears as continuous interference. Meanwhile, by adjusting the rotational speed of the radar antenna to avoid co-frequency or harmonic, with no need to change ‘transmission parameters of the radar system, and the radar can operate “covertly” in the direction. If the interference is a continuous co-frequency interference, the interference can be eliminated by adjusting the ‘transmission frequency of the radar system.

In one embodiment of the present application, the “determine a first target to be processed is same as a second target to be processed when an absolute value of difference in azimuth AZ between the first target to be processed and the second target to be processed is less than an azimuth difference threshold ΔAZ” specifically comprises: determining a first target to be processed is same as a second target to be processed and updating attribute values of a seventh target to be processed in the scanned target collection with attribute values of the first target to be processed when the absolute value of the difference in azimuth AZ between the first target to be processed and the second target to be processed is less than an azimuth difference threshold ΔAZ, where content of the second target to be processed is the same as content of the seventh target to be processed; and
the “determine a first target to be processed is a new target when an absolute value of difference in azimuth AZ between the first target to be processed and any initial target among the Num1 initial targets is greater than or equal to an azimuth difference threshold ΔAZ” specifically comprises: determining a first target to be processed is a new target and adding the first target to be processed to the scanned target collection when the absolute value of the difference in azimuth AZ between the first target to be processed and any initial target among the Num1 initial targets is greater than or equal to the azimuth difference threshold ΔAZ.

In one embodiment of the present application, the signal processing method further comprises following steps:
perform a processing as follows on each initial target in the scanned target collection:
removing an initial target from the scanned target collection when an absolute value of difference between a most recent appearance time of the initial target and a current time is less than a second preset time threshold ΔTime2.

A second embodiment of the present application provides a signal processing device for radar systems, comprising following modules:
a data acquisition module, configured to acquire a scanned target collection, which includes Num1 initial targets and corresponding Num1 attribute values, control a radar system to perform a scanning operation, and obtain Num2 initial targets and corresponding Num2 attribute values based on a radar echo signal, where the attribute values include at least: an azimuth AZ of the initial target, appearance time of the initial target, amplitude of the radar echo signal, and signal-to-noise ratio (SNR) S_N of the radar echo signal, with Num1 and Num2 being natural numbers;
a clustering module, configured to copy the Num1 initial targets into corresponding Num1 targets to be processed, and copy the Num2 initial targets into corresponding Num2 targets to be processed; and configured to divide Num1+Num2 targets to be processed into multiple clusters based on a clustering algorithm and azimuths AZ of the Num1+Num2 targets to be processed;
a noise processing module, configured to perform a processing as follows on each second cluster among the multiple clusters: deleting a second cluster if the signal-to-noise ratio S_N of targets to be processed in the second cluster does not meet a preset condition; and
a processing module, configured to perform a first processing on each first cluster among the multiple clusters: counting M targets to be processed in the first cluster, where an absolute value of difference between an appearance time of the M targets to be processed and a current time is less than a first preset time threshold ΔTime1; configured to divide the M targets to be processed into N clusters when M is greater than a first preset quantity threshold, where in each cluster among the N clusters, an absolute value of difference in amplitude between any two targets to be processed is less than a preset amplitude threshold; configured to delete a cluster, when a number of targets to be processed contained in the cluster is greater than a second preset quantity threshold, for any cluster; configured to perform a second processing on each remaining cluster: determining a first target to be processed is same as a second target to be processed when an absolute value of difference in azimuth AZ between the first target to be processed and the second target to be processed is less than an azimuth difference threshold ΔAZ; and determining a first target to be processed is a new target when an absolute value of difference in azimuth AZ between the first target to be processed and any initial target among the Num1 initial targets is greater than or equal to an azimuth difference threshold ΔAZ; where the first target to be processed is any target to be processed in the cluster, the second target to be processed is any initial target among the Num1 initial targets, M and N are both natural numbers, N≤M; configured to proceed to perform a next second processing when there are still clusters that have not undergone the second processing; and configured to proceed to perform a next first processing when there are still first clusters that have not undergone the first processing.

A third embodiment of the present application provides a storage medium stored program instruction, characterized in that the program instructions, when the program instructions are executed, a signal processing method described in a first embodiment of the present application is implemented.

A third embodiment of the present application provides an electronic terminal, comprising a processor and a memory, with the memory storing program instructions, characterized in that the processor runs the program instructions to implement a signal processing method as described in a first embodiment.

It should be understood that although the specification is described in terms of embodiments, not every embodiment contains only a single technical solution, and the form of description in the specification is only for clarity. Those skilled in the art should consider the specification as a whole, the technical solutions in the various embodiments can also be appropriately combined to form other embodiments understood by those skilled in the art.

The series of detailed explanations listed above are only for the specific elaboration of feasible embodiments of the present application and are not intended to limit the scope of the present application. Any equivalent embodiments or changes made without departing from the spirit of the present application should be included within the scope of protection of the present application.

1. A signal processing method for radar systems, characterized by comprising following steps:
acquiring a scanned target collection, which includes Num1 initial targets and corresponding Num1 attribute values, controlling a radar system to perform a scanning operation, and obtaining Num2 initial targets and corresponding Num2 attribute values based on a radar echo signal, where the attribute values include at least: an azimuth AZ of the initial target, appearance time of the initial target, amplitude of the radar echo signal, and signal-to-noise ratio S_N of the radar echo signal, with Num1 and Num2 being natural numbers;
copying the Num1 initial targets into corresponding Num1 targets to be processed, and copying the Num2 initial targets into corresponding Num2 targets to be processed; dividing Num1+Num2 targets to be processed into multiple clusters based on a clustering algorithm and azimuths AZ of the Num1+Num2 targets to be processed;
performing a processing as follows on each second cluster: deleting a second cluster if signal-to-noise ratio S_N of targets to be processed in the second cluster does not meet a preset condition;
performing a first processing on each first cluster among the multiple clusters: counting M targets to be processed in the first cluster, where an absolute value of difference between an appearance time of the M targets to be processed and a current time is less than a first preset time threshold ΔTime1; dividing the M targets to be processed into N clusters when M is greater than a first preset quantity threshold, where in each cluster among the N clusters, an absolute value of difference in amplitude between any two targets to be processed is less than a preset amplitude threshold; deleting a cluster when a number of targets to be processed contained in the cluster is greater than a second preset quantity threshold, for any cluster; performing a second processing on each remaining cluster: determining a first target to be processed is same as a second target to be processed when an absolute value of difference in azimuth AZ between the first target to be processed and the second target to be processed is less than an azimuth difference threshold ΔAZ; and determining a first target to be processed is a new target when an absolute value of difference in azimuth AZ between the first target to be processed and any initial target among the Num1 initial targets is greater than or equal to an azimuth difference threshold ΔAZ; where the first target to be processed is any target to be processed in the cluster, the second target to be processed is any initial target among the Num1 initial targets, M and N are natural numbers, N≤M; performing a next second processing when there are still clusters that have not undergone the second processing; and performing a next first processing when there are still first clusters that have not undergone the first processing.

2. The signal processing method according to claim 1, characterized in that the “dividing Num1+Num2 targets to be processed into multiple clusters based on a clustering algorithm and azimuths AZ of the Num1+Num2 targets to be processed” specifically comprises:
processing the Num1+Num2 targets to be processed as follows until all the Num1+Num2 targets to be processed have been processed, and the processing on the Num1+Num2 targets to be processed specifically comprises: selecting an unprocessed third target to be processed from the Num1+Num2 targets to be processed, creating a cluster that only comprises the third target to be processed, marking the third target to be processed as processed, and determining each fourth target to be processed among the Num1+Num2 targets to be processed as follows: adding the fourth target to be processed to the cluster, and marking the fourth target to be processed as processed when a fourth initial target is unprocessed, and an absolute value of difference in azimuth AZ between the third target to be processed and an average azimuth of all targets to be processed in the cluster is less than the azimuth difference threshold ΔAZ.

3. The signal processing method according to claim 1, characterized in that the “deleting a second cluster if signal-to-noise ratio S_N of targets to be processed in the second cluster does not meet a preset condition” specifically comprises:
obtaining a number Counter1 of fifth targets to be processed in the second cluster and a number Counter2 of sixth targets to be processed in the second cluster, where an absolute value of difference between an appearance time of the fifth target to be processed and a current time is less than or equal to a first preset time threshold ΔTime1, and an absolute value of difference between a signal-to-noise ratio S_N of the sixth target to be processed and a preset signal-to-noise ratio value is less than or equal to a preset signal-to-noise ratio threshold ΔS_N; deleting the second cluster if Counter2/Counter1 is greater than a preset percentage value.

4. The signal processing method according to claim 3, characterized in that a preset percentage value is 0.9.

5. The signal processing method according to claim 3, characterized in that the “deleting a second cluster if signal-to-noise ratio S_N of targets to be processed in the second cluster does not meet a preset condition” specifically comprises:
deleting the second cluster and adjusting a rotational speed of the radar system and a transmission frequency of the radar system if the signal-to-noise ratio S_N of the targets to be processed in the second cluster does not meet the preset condition.

6. The signal processing method according to claim 1, characterized in that the “determining a first target to be processed is same as a second target to be processed when an absolute value of difference in azimuth AZ between the first target to be processed and the second target to be processed is less than an azimuth difference threshold ΔAZ” specifically comprises:
determining a first target to be processed is same as a second target to be processed and updating attribute values of a seventh target to be processed in the scanned target collection with attribute values of the first target to be processed when the absolute value of the difference in azimuth AZ between the first target to be processed and the second target to be processed is less than the azimuth difference threshold ΔAZ;
the “determining a first target to be processed is a new target when an absolute value of difference in azimuth AZ between the first target to be processed and any initial target among the Num1 initial targets is greater than or equal to an azimuth difference threshold ΔAZ” specifically comprises: determining a first target to be processed is a new target and adding the first target to be processed to the scanned target collection when the absolute value of the difference in azimuth AZ between the first target to be processed and any initial target among the Num1 initial targets is greater than or equal to the azimuth difference threshold ΔAZ.

7. The signal processing method according to claim 6, characterized in that the signal processing method further comprises following steps:
performing a processing as follows on each initial target in the scanned target collection: removing an initial target from the scanned target collection when an absolute value of difference between a most recent appearance time of the initial target and a current time is less than a second preset time threshold ΔTime2.

8. A signal processing device for radar systems, characterized by comprising following modules:
a data acquisition module, configured to acquire a scanned target collection, which includes Num1 initial targets and corresponding Num1 attribute values, control a radar system to perform a scanning operation, and obtain Num2 initial targets and corresponding Num2 attribute values based on a radar echo signal, where the attribute values include at least: an azimuth AZ of the initial target, appearance time of the initial target, amplitude of the radar echo signal, and signal-to-noise ratio S_N of the radar echo signal, with Num1 and Num2 being natural numbers;
a clustering module, configured to copy the Num1 initial targets into corresponding Num1 targets to be processed, and copy the Num2 initial targets into corresponding Num2 targets to be processed; and configured to divide Num1+Num2 targets to be processed into multiple clusters based on a clustering algorithm and azimuths AZ of the Num1+Num2 targets to be processed;
a noise processing module, configured to perform a processing as follows on each second cluster among the multiple clusters: deleting a second cluster if signal-to-noise ratio S_N of targets to be processed in the second cluster does not meet a preset condition;
a processing module, configured to perform a first processing on each first cluster among the multiple clusters: counting M targets to be processed in the first cluster where an absolute value of difference between an appearance time of the M targets to be processed and a current time is less than a first preset time threshold ΔTime1; configured to divide the M targets to be processed into N clusters when M is greater than a first preset quantity threshold, where in each cluster among the N clusters, an absolute value of difference in amplitude between any two targets to be processed is less than a preset amplitude threshold; configured to delete a cluster, when a number of targets to be processed contained in the cluster is greater than a second preset quantity threshold, for an y cluster; configured to perform a second processing on each remaining cluster: determining a first target to be processed is same as a second target to be processed when an absolute value of difference in azimuth AZ between the first target to be processed and the second targets to be processed is less than an azimuth difference threshold ΔAZ; and determining a first target to be processed is a new target when an absolute value of difference in azimuth AZ between the first target to be processed and any initial target among the Num1 initial targets is greater than or equal to an azimuth difference threshold ΔAZ; where the first target to be processed is any target to be processed in the cluster, the second target to be processed is any initial target among the Num1 initial targets, M and N are natural numbers, N≤M; configured to perform a next second processing when there are still clusters that have not undergone the second processing; and configured to perform a next first processing when there are still first clusters that have not undergone the first processing.

9. A storage medium, characterized in that the storage medium stores program instructions, when the program instructions are executed, a signal processing method according to claim 1 is implemented.

10. (canceled)

11. A storage medium, characterized in that the storage medium stores program instructions, when the program instructions are executed, a signal processing method according to claim 2 is implemented.

12. A storage medium, characterized in that the storage medium stores program instructions, when the program instructions are executed, a signal processing method according to claim 3 is implemented.

13. A storage medium, characterized in that the storage medium stores program instructions, when the program instructions are executed, a signal processing method according to claim 4 is implemented.

14. A storage medium, characterized in that the storage medium stores program instructions, when the program instructions are executed, a signal processing method according to claim 5 is implemented.

15. A storage medium, characterized in that the storage medium stores program instructions, when the program instructions are executed, a signal processing method according to claim 6 is implemented.

16. A storage medium, characterized in that the storage medium stores program instructions, when the program instructions are executed, a signal processing method according to claim 7 is implemented.
